(19) United States
(12) Patent Application Publication
(10) Pub. No.: US 2026/0109052 A1
(43) Pub. Date: Apr. 23, 2026

(54) MAGNETIC GRIPPER, MAGNETIC GRIPPER DEVICE, GRIPPING DEVICE FOR GRIPPING A FERROMAGNETIC WORKPIECE, AND GRIPPING SYSTEM

(71) Applicant: J. Schmalz GmbH, Glatten (DE)

(72) Inventor: Tobias Eberhardt, Glatten (DE)

(21) Appl. No.: 19/238,907

(22) Filed: Jun. 16, 2025

(30) Foreign Application Priority Data
Jun. 20, 2024 (DE) 10 2024 117 380.7

(51) Int. Cl. B25J 15/06

(52) U.S. Cl. CPC B25J 15/0608

(57) ABSTRACT

A magnetic gripper (10, 104, 106, 204, 206) for gripping a ferromagnetic workpiece (36, 202). The magnetic gripper (10, 104, 106, 204, 206) has a magnetic apparatus (18), a transfer apparatus (20) and a workpiece contact surface (22). The magnetic apparatus (18) is formed from a number of permanent magnets (26) with a north pole and a south pole and can be transferred between a gripping state for gripping the ferromagnetic workpiece (36, 202) and a release state for releasing the ferromagnetic workpiece (36, 202). The transfer apparatus (20) is designed to transfer the magnetic apparatus (18) between the gripping state and the release state. The workpiece contact surface (22) is designed to contact the ferromagnetic workpiece (36, 202).

The invention relates to a magnetic gripper, a magnetic gripper device and a gripping device for gripping a ferromagnetic workpiece as well as a gripping system.

Typically, such apparatuses are used for handling ferromagnetic workpieces. The requirements depend heavily on the geometry and material properties of the workpieces to be gripped (small parts, metal sheets, etc.) as well as on the handling task or gripping task to be performed (positioning, unstacking, separating, etc.).

The object on which the invention is based is to enable secure gripping of ferromagnetic workpieces, and to perform specific gripping tasks such as the unstacking of metal sheets or the gripping and separating of sensitive and/or delicate workpieces.

The invention achieves this object by a magnetic gripper having the features of claim 1, a magnetic gripper device having the features of claim 7, a gripping device having the features of claim 11, and a gripping system having the features of claim 12. Advantageous embodiments and developments of the invention emerge from the dependent claims.

A magnetic gripper according to the invention is designed to grip a ferromagnetic workpiece. The magnetic gripper has a magnetic apparatus, a transfer apparatus and a workpiece contact surface. The magnetic apparatus is formed from a number of permanent magnets, each with a north pole and a south pole. In principle, one permanent magnet can be sufficient at first. However, it can be advantageous to provide a plurality (at least two) permanent magnets. It is also advantageous to provide a larger number, in particular more than two, permanent magnets. In this respect, the number mentioned can be, for example, 1, 2, 3, 6, 12, 24 or 48. The magnetic apparatus can be transferred between a gripping state for gripping the ferromagnetic workpiece and a release state for releasing the ferromagnetic workpiece. For this purpose, the transfer apparatus is provided which is designed to transfer the magnetic apparatus between the gripping state and the release state, i.e., to switch in a controlled manner into the gripping state or the release state, depending on which state is desired. The workpiece contact surface is designed to contact the ferromagnetic workpiece.

Advantageously, the provision of the number of permanent magnets makes it possible for the ferromagnetic workpiece to be gripped particularly securely by means of the magnetic gripper. Furthermore, the number of permanent magnets can enable specific purchasing tasks such as stacking metal sheets to be performed.

A further aspect of the magnetic gripper can be that the number of permanent magnets, in particular a plurality of permanent magnets, can result in a more continuous and constant magnetic force acting on the ferromagnetic workpiece, whereby the ferromagnetic workpiece is gripped particularly securely by the magnetic gripper. The number of permanent magnets can also enable a flexible design of the magnetic gripper, which allows the magnetic gripper to be modularized in the form of a modular system.

The magnetic gripper can have a handling interface for attaching the magnetic gripper to a handling device. The handling device can be designed as a manipulator, for example in the form of a robot arm. The handling interface can advantageously enable a particularly simple and quick connection of the magnetic gripper to the handling device. The handling interface can be designed for tool-free attachment of the magnetic gripper to the handling device and/or for tool-free detachment of the magnetic gripper from the handling device. The handling interface can be designed as a quick coupling, for example in the form of a bayonet lock.

The handling interface and the workpiece contact surface can preferably be electrically insulated from each other.

The magnetic gripper can have an adapter plate with the handling interface. The adapter plate can preferably be formed from an electrically insulating material, in particular for electrically insulating the handling interface from the workpiece contact surface. The material of the adapter plate can be a plastic, in particular a polyamide. The adapter plate and the workpiece contact surface can be arranged at opposite ends of the magnetic gripper. The adapter plate can at least partially form an end face of the magnetic gripper.

The ferromagnetic workpiece can be made of iron or steel. The workpiece can be a metal sheet or a material panel. The workpiece can be delicate. In particular, a width and/or a length of the workpiece can be more than five times, in particular ten times, a thickness of the workpiece. The thickness of the workpiece can, for example, be an amount in a range from 0.5 mm (millimeters) to 5 cm (centimeters), in particular 0.5 mm to 5 mm.

The workpiece contact surface can be understood as a surface of the magnetic gripper against which the gripped ferromagnetic workpiece rests. The workpiece contact surface can be a surface of the magnetic gripper that forms a touching contact with the gripped ferromagnetic workpiece. The workpiece contact surface can be described as the contact surface for the ferromagnetic workpiece.

The workpiece contact surface can be flat. This can be useful because, for workpieces with typical proportions, the contact area for the magnetic gripper is often at least approximately flat. A flat workpiece contact surface is also often useful for unstacking a stack of magnetic metal sheets or the like. An uneven, e.g., curved, workpiece contact surface can, however, be useful if the workpiece is to be contacted in a correspondingly uneven, e.g., curved, area.

The workpiece contact surface can form an end face of the magnetic gripper, at least partially. The workpiece contact surface can be arranged at one end of the magnetic gripper.

The magnetic gripper can have a housing. The magnetic apparatus and/or the transfer apparatus can be arranged in the housing. The housing can be non-magnetizable. The housing can be made of a non-ferromagnetic material such as aluminum.

The housing can be elongated. The housing can extend along a longitudinal axis of the housing and/or a longitudinal axis of the magnetic gripper. The longitudinal axis of the magnetic gripper and the longitudinal axis of the housing can be the same.

The housing can have the workpiece contact surface completely or partially. In particular, at least a section of the workpiece contact surface can be a surface of the housing. In other words, the housing can form the workpiece contact surface partially or completely.

The magnetic apparatus can have at least five, in particular nine, permanent magnets.

Each permanent magnet can also be called a PM. Each permanent magnet can be supported by the housing. The housing can have an interior space in which each permanent magnet is arranged.

Each permanent magnet can be designed to generate a magnetic field. The magnetic field of each permanent magnet can extend from the north pole to the south pole of the permanent magnet. The magnetic fields of all permanent magnets of the magnetic apparatus can form the magnetic field of the magnetic apparatus. The permanent magnets can be arranged relative to one another in such a way that their magnetic fields, in particular in the release state and/or in the gripping state, overlap one another to form the magnetic field of the magnetic apparatus.

The permanent magnets can be arranged in a line, in particular forming a permanent magnet row, or in an area, in particular forming a permanent magnet matrix. The permanent magnet matrix can be understood to be permanent magnet grid or a permanent magnet lattice.

The magnetic apparatus can have at least two permanent magnets which are arranged, in particular next to one another, to form the permanent magnet row.

The magnetic apparatus can have at least four permanent magnets which are arranged, in particular next to one another, to form the permanent magnet matrix. For example, if the magnetic apparatus has exactly four permanent magnets, the permanent magnets can be arranged to form a 2×2 permanent magnet matrix.

The magnetic apparatus can be formed in one piece. In particular, the magnetic apparatus can have a plurality, in particular at least two, of permanent magnets and be formed in one piece. Each permanent magnet can form a segment of the magnetic apparatus. In other words, the magnetic apparatus can be magnetized with multiple poles.

The permanent magnets can be arranged next to one another to form the magnetic apparatus, in particular in the release state and/or in the gripping state. In particular, the number of permanent magnets can be arranged one after the other to form the permanent magnet row. The permanent magnet row can be formed by arranging the number of permanent magnets next to one another, in particular linearly. Alternatively, the number of permanent magnets can be arranged next to each other to form the permanent magnet matrix. The permanent magnet matrix can be formed by arranging the number of permanent magnets in rows and columns.

The number of permanent magnets can be arranged in such a way that at least two adjacent permanent magnets form a touching contact between them. In particular, each permanent magnet can have at least one touching contact with an adjacent permanent magnet.

In the gripping state, the magnetic apparatus can generate a magnetic field which is designed to apply to the ferromagnetic workpiece a magnetic force that is directed onto the workpiece contact surface and is preferably greater than a weight force of the ferromagnetic workpiece. In particular, the magnetic apparatus can be designed to push or press the ferromagnetic workpiece against the workpiece contact surface by means of a magnetic force in the gripping state for the purpose of gripping the ferromagnetic workpiece.

In the release state, the magnetic apparatus cannot generate a magnetic field that is designed to apply to the ferromagnetic workpiece a magnetic force that is directed onto the workpiece contact surface and is greater than a weight force of the ferromagnetic workpiece. In particular, the magnetic apparatus can be designed so that in the release state the ferromagnetic workpiece is not pushed or pressed against the workpiece contact surface by means of a magnetic force for the purpose of releasing the ferromagnetic workpiece.

The magnetic gripper can have a number, in particular 1 or 2, of pole shoes. Each pole shoe can be designed to guide a magnetic field component of the magnetic field of the magnetic apparatus to the workpiece contact surface, in particular to the ferromagnetic workpiece, for gripping the ferromagnetic workpiece. Each pole shoe can be made of a material that has the property of amplifying and/or conducting magnetic fields. Each pole shoe can be made of a ferromagnetic material, in particular iron, steel, nickel, or cobalt.

Each pole shoe can be detachably attached to the housing, for example by means of a screw connection. Advantageously, the pole shoes can thus be replaced, for example when the pole shoes are worn out or when other pole shoes with special properties are to be used to fulfill a specific gripping task.

The number of pole shoes can have the workpiece contact surface completely or partially. In particular, at least a section of the workpiece contact surface can be a surface of a pole shoe. In other words, the number of pole shoes can form the workpiece contact surface partially or completely.

The magnetic gripper can have an attachment that has the workpiece contact surface. The attachment can be placed on the housing of the magnetic gripper, in particular plugged or screwed on. The attachment can be provided, for example, by a plastic injection-molded part or a rubber part. Advantageously, damage to the ferromagnetic workpiece during gripping can thereby be reduced or completely avoided.

The number of permanent magnets can be mounted in the housing so as to be linearly displaceable, in particular along the longitudinal axis of the magnetic gripper or in a direction orthogonal to the workpiece contact surface, and/or rotatable, in particular about a transverse axis of the magnetic gripper.

The magnetic apparatus can be transferred between the gripping state and the release state by a translational movement of the number of permanent magnets. The translational movement can be a straight movement, in particular a vertical movement. For example, the magnetic apparatus can be transferred between the gripping state and the release state by a linear displacement of the number of permanent magnets, in particular in a direction parallel to the longitudinal axis of the magnetic gripper or in a direction orthogonal to the workpiece contact surface.

For example, the transfer from the release state to the gripping state can be achieved by a linear displacement of the number of permanent magnets within the housing toward the workpiece contact surface. The transfer from the gripping state to the release state can be achieved by a linear displacement of the number of permanent magnets within the housing away from the holding surface.

Additionally or alternatively, the magnetic apparatus can be transferred between the gripping state and the release state by a rotational movement of the number of permanent magnets. For example, every second permanent magnet or all permanent magnets can be rotated by 180° to transfer the magnetic apparatus between the gripping state and the release state.

If the number of permanent magnets can be transferred between the release state and the gripping state by a rotational movement, each permanent magnet can be formed from two separate permanent magnet segments which are rotated against each other to transfer between the release state and the gripping state. As a result, the magnetic fields of the two permanent magnet segments can cancel each other out in the release state or not cancel each other out in the gripping state, and in particular can be amplified in the gripping state.

The transfer apparatus can be designed to drive the translational movement and/or the rotational movement. In particular, the transfer apparatus can be designed to move the number of permanent magnets pneumatically, electrically or mechanically for the purpose of transferring the magnetic apparatus between the gripping state and the release state.

The transfer apparatus can comprise an actuator for transferring the magnetic apparatus between the gripping state and the release state. The actuator can be designed to drive the translational movement and/or the rotational movement of the number of permanent magnets. The actuator can be an electric motor, an electric linear actuator, a lever and/or a pneumatic drive. In particular, the actuator can be designed as a pneumatic piston which is directly or indirectly connected to the number of permanent magnets. The housing can have a pneumatic cylinder in which the pneumatic piston is arranged.

Additionally or alternatively, the magnetic apparatus can be transferred between the gripping state and the release state by a translational movement of at least one ferromagnetic metal sheet of the magnetic gripper. For example, the ferromagnetic metal sheet can be inserted into or removed from the magnetic apparatus for the purpose of transferring the magnetic apparatus between the gripping state and the release state. The transfer apparatus, in particular the actuator, can be designed to insert the metal sheet into or remove it from the magnetic apparatus.

Additionally or alternatively, the magnetic gripper can comprise a number of further permanent magnets for transferring the magnetic apparatus between the gripping state and the release state. For example, the number of further permanent magnets can be inserted into or removed from the magnetic apparatus for the purpose of transferring the magnetic apparatus between the gripping state and the release state. The transfer apparatus, in particular the actuator, can be designed to insert the number of further permanent magnets into or remove them from the magnetic apparatus. As a result, in the inserted state, the magnetic fields of the further permanent magnets can weaken, in particular cancel out, the magnetic fields of the permanent magnets, or not weaken them in the removed state. In the inserted state, the magnetic apparatus can be in the release state and, in the removed state, can be in the gripping state.

Additionally or alternatively, the magnetic gripper can have a number of coils for transferring the magnetic apparatus between the gripping state and the release state. Each coil can have at least one winding of a current conductor made of wire. Each coil can have a bobbin on which the winding is wound. The bobbin can have a soft magnetic core. The number of coils can be equal to the number of permanent magnets. Each permanent magnet can be assigned a coil. For example, the number of coils can be energized with electric current for the purpose of transferring the magnetic apparatus between the gripping state and the release state. By energizing the coils with electric current, a magnetic field can be generated by the coils that is opposite to the magnetic field of the number of permanent magnets. As a result, the magnetic field of the number of permanent magnets can be weakened, in particular neutralized, when the coils are energized, whereby the magnetic gripper is in the release state. If the coils are not energized, the magnetic gripper can be in the gripping state. The transfer apparatus can be designed as a voltage source for energizing the coils. The coils can be electrically connected to the transfer apparatus in the form of the voltage source.

The magnetic gripper can have a detector for detecting the gripping state and/or the release state. In particular, the detector can be designed to detect a position of the magnetic apparatus, in particular in the housing.

The magnetic gripper can have a control apparatus for controlling the transfer apparatus, in particular the actuator. The control apparatus can have a microcontroller. The control apparatus can be designed to initiate and/or control the transfer of the magnetic apparatus between the gripping state and the release state by controlling the transfer apparatus, in particular the actuator. This can be done depending on the gripping state detected by the detector or the detected release state.

In the gripping state, the magnetic apparatus can be spaced at a distance from the workpiece contact surface. By adjusting the distance, the magnetic force acting on the ferromagnetic workpiece in the gripping state can be adjusted. In particular, by adjusting the distance, the magnetic field of the magnetic apparatus penetrating through the workpiece contact surface can be adjusted, thereby enabling the adjustment of the magnetic force acting on the ferromagnetic workpiece.

The control apparatus can be designed to determine the distance based on the position of the magnetic apparatus detected by the detector. The control apparatus can be designed to control the transfer into the gripping state in such a way that the magnetic apparatus is spaced at a target distance from the workpiece contact surface. The control apparatus can be designed to determine the target distance based on a predetermined magnetic force. The predetermined magnetic force can be a maximum magnetic force with which the ferromagnetic workpiece can be acted upon without the ferromagnetic workpiece being damaged by the magnetic force.

In other words, the control apparatus can be designed to control the transfer apparatus to reduce or increase the magnetic field of the magnetic apparatus penetrating through the workpiece contact surface in the gripping state.

The magnetic force acting on the ferromagnetic workpiece is adjusted segment by segment by means of the control apparatus. This allows the magnetic field of the magnetic apparatus to be adapted to the geometry of the ferromagnetic workpiece.

The magnetic gripper can have a sensor apparatus with one or more, for example 2, 4 or 6, presence sensors. The sensor apparatus, in particular each presence sensor, can be designed to detect whether the ferromagnetic workpiece is located on, in particular lies against, the workpiece contact surface. Each presence sensor can be designed as a mechanical sensor, as an optical sensor or as an inductive sensor, in particular as a magnetic field sensor, preferably a Hall sensor.

The sensor apparatus, in particular each presence sensor, can be designed to detect a thickness of the ferromagnetic workpiece and/or the material located under the ferromagnetic workpiece. The control apparatus can be designed to initiate and/or control the transfer of the magnetic apparatus between the gripping state and the release state depending on the thickness of the ferromagnetic workpiece detected by the sensor apparatus and/or the material located under the ferromagnetic workpiece detected by the sensor apparatus. Advantageously, this allows classification and checking of the ferromagnetic workpiece and/or adjustment of the magnetic force required for gripping the ferromagnetic workpiece. In particular, by detecting the thickness of the ferromagnetic workpiece, the magnetic force for gripping the ferromagnetic workpiece can be adjusted in such a way that bending and/or damage to the ferromagnetic workpiece is prevented.

A further aspect of the sensor apparatus, in particular the presence sensors, can be that it enables component sorting, reduces residual magnetism and/or allows quality control of the component.

A further aspect of the magnetic apparatus can be that the number of permanent magnets is arranged in such a way that a uniformly distributed magnetic force acts on the ferromagnetic workpiece.

A further aspect of the magnetic gripper can be that the number of permanent magnets, in particular a plurality of permanent magnets, enables segment-by-segment switching on and off of individual permanent magnets. This allows the magnetic gripper to be adapted to differently shaped ferromagnetic workpieces, which is why the magnetic gripper can be used particularly flexibly.

In a further development of the magnetic gripper, the magnetic apparatus has a first side facing the workpiece contact surface, in particular in the gripping state, and a second side facing away from the workpiece contact surface, in particular in the gripping state. The number of permanent magnets are arranged in such a way that a magnetic flux density of the magnetic field of the magnetic apparatus at or through the first side is higher than a magnetic flux density of the magnetic apparatus at or through the second side. Advantageously, this allows the magnetic apparatus to be designed particularly compact, which results in space savings. Another aspect can be that this allows a higher magnetic force to be achieved with the same usage of material for the permanent magnets.

A higher magnetic flux density of the magnetic field of the magnetic apparatus at or through the first side than at or through the second side can be understood to mean that the field lines of the permanent magnets on the first side are closer together than the field lines of the permanent magnets on the second side.

The first side and the second side can be arranged opposite each other. The number of permanent magnets can be arranged in such a way that the magnetic field of the magnetic apparatus is concentrated on the first side, and the magnetic field of the magnetic apparatus is weakened and/or almost canceled out on the second side.

In a further development of the magnetic gripper, the number of permanent magnets are arranged in a Halbach row or in a Halbach matrix. This makes it particularly easy to ensure that the magnetic flux density of the magnetic field of the magnetic apparatus is higher at or through the first side than at or through the second side. The permanent magnet row can be designed as a Halbach row. The permanent magnet matrix can be designed as a Halbach matrix.

A Halbach row can be understood as a Halbach array. The Halbach matrix can be formed by arranging a plurality of Halbach rows next to each other. Each Halbach row of the Halbach matrix can extend along a longitudinal axis. The longitudinal axes of the Halbach rows of the Halbach matrix can be aligned parallel to each other.

In a further development of the magnetic gripper, the magnetic apparatus has a first magnet unit that is formed from at least one permanent magnet and a second magnet unit that is formed from at least one permanent magnet. The transfer apparatus is designed to transfer the first magnet unit between an active state and a passive state independently of the second magnet unit. The transfer apparatus is designed to transfer the second magnet unit between an active state and a passive state independently of the first magnet unit. The magnetic gripper is in the release state when the first magnet unit and the second magnet unit are each in the passive state. The magnetic gripper is in the gripping state when the first magnet unit and/or the second magnet unit is in the active state.

Advantageously, this allows the magnetic force that presses the ferromagnetic workpiece against the workpiece contact surface to be controlled. For example, a greater magnetic force can act on the ferromagnetic workpiece when the first magnet unit and the second magnet unit are in the active state than when the first magnet unit is in the active state and the second magnet unit is in the passive state, or the first magnet unit is in the passive state and the second magnet unit is in the active state. This allows the magnetic gripper to be able to grip both sensitive and insensitive ferromagnetic workpieces.

The control apparatus can be designed to initiate and/or control the transfer of the first magnet unit and/or the second magnet unit between the active state and the passive state by controlling the transfer apparatus.

In the active state of a magnet unit, a distance between the magnet unit and the workpiece contact surface can be smaller than in the passive state of the magnet unit.

The first magnet unit and the second magnet unit can have an equal number of permanent magnets. The first magnet unit can be formed from 2, 3, 4, 5 or 6 permanent magnets, and/or the second magnet unit can be formed from 2, 3, 4, 5 or 6 permanent magnets.

The magnetic gripper can have more than the two magnet units.

In a further development of the magnetic gripper, the magnetic gripper has a magnetic gripper interface for releasably attaching a further magnetic gripper to the magnetic gripper. The magnetic gripper interface can advantageously enable a particularly simple and quick attachment of the magnetic gripper and the further magnetic gripper to one another. Advantageously, this allows an adaptation to the size of the ferromagnetic workpiece, whereby large ferromagnetic workpieces can be gripped.

The magnetic gripper and the further magnetic gripper can be structurally identical.

The magnetic gripper interface can have a threaded hole and/or a through hole for establishing a screw connection between the magnetic gripper and the further magnetic gripper for releasably attaching the two magnetic grippers to one another. The housing of the magnetic gripper can have the magnetic gripper interface.

The magnetic gripper interface can be designed to supply the further magnetic gripper with energy, in particular electrical energy, and/or compressed air via the magnetic gripper.

The magnetic gripper interface can be designed to align the magnetic gripper and the further, in particular structurally identical, magnetic gripper relative to each other. For example, the magnetic gripper interface can be designed to attach the magnetic gripper and the further magnetic gripper to one another in such a way that the workpiece contact surface of the magnetic gripper and a workpiece contact surface of the further magnetic gripper are arranged in one, in particular common, plane. Alternatively, the magnetic gripper interface can be designed to attach the magnetic gripper and the further magnetic gripper to one another in such a way that a contour of a workpiece contact surface of the magnetic gripper and a contour of a workpiece contact surface of the further magnetic gripper at least partially follow a contour of the ferromagnetic workpiece.

In a further development of the magnetic gripper, the magnetic gripper has a number, for example 1, 2 or 4, of grippers for gripping the ferromagnetic workpiece. Each gripper is designed to grip the ferromagnetic workpiece without a magnetic field. Advantageously, this allows the magnetic gripper to implement other gripping principles in addition to gripping the ferromagnetic workpiece by means of a magnetic force.

In particular, not every gripper has to be designed as a magnetic gripper. For each of the grippers, it is conceivable that it is designed as a suction gripper for gripping the ferromagnetic workpiece by means of a negative pressure. Each gripper can be integrated into the permanent magnet matrix. For example, a gripper can be arranged at a location on the permanent magnet matrix at which at least one permanent magnet would be provided. Alternatively, the magnetic gripper can have a sealing cord for contacting the ferromagnetic workpiece and for forming a negative pressure area of the magnetic gripper. The negative pressure area can be subjected to the negative pressure so that the ferromagnetic workpiece is sucked against the sealing cord and against the workpiece contact surface of the magnetic gripper by the negative pressure.

A magnetic gripper device according to the invention is suitable for gripping a ferromagnetic workpiece. The magnetic gripper device comprises a magnetic gripping point, a first magnetic gripper as previously described and a second magnetic gripper as previously described. The magnetic gripping point is designed to grip the ferromagnetic workpiece. The first magnetic gripper and the second magnetic gripper are arranged next to each other to form the magnetic gripping point. Advantageously, this allows the two magnetic grippers to act like a single magnetic gripper. In particular, it can thereby be achieved that the ferromagnetic workpiece can be gripped with a magnetic force that is equal to the sum of the magnetic forces of the two magnetic grippers. This allows the ferromagnetic workpiece to be gripped with a greater magnetic force.

The first magnetic gripper and the second magnetic gripper can be structurally identical. The first magnetic gripper and the second magnetic gripper can be arranged next to each other to form a touching contact. In particular, the first magnetic gripper and the second magnetic gripper can be arranged next to each other in such a way that the two magnetic grippers touch each other.

The first magnetic gripper and the second magnetic gripper can be arranged next to one another in such a way that the workpiece contact surface of the first magnetic gripper and the workpiece contact surface of the second magnetic gripper are arranged in one, in particular common, plane. Alternatively, the first magnetic gripper and the second magnetic gripper can be arranged next to one another in such a way that a contour of the workpiece contact surface of the first magnetic gripper and a contour of the workpiece contact surface of the second magnetic gripper at least partially follow the contour of the ferromagnetic workpiece.

The workpiece contact surface of the first magnetic gripper can be spaced from the workpiece contact surface of the second magnetic gripper by a contact surface spacing of the magnetic gripper device. The contact surface spacing can be smaller than a diameter of the first magnetic gripper and/or a diameter of the second magnetic gripper. In particular, the contact surface spacing can be an amount less than 5 cm, in particular 3 cm, 2 cm or 1 cm.

The magnetic gripping point can be formed by the workpiece contact surface of the first magnetic gripper and the workpiece contact surface of the second magnetic gripper. The workpiece contact surface of the first magnetic gripper and the workpiece contact surface of the second magnetic gripper can be arranged in one plane to form the magnetic gripping point.

The first magnetic gripper can be releasably attached to the second magnetic gripper, in particular by means of a screw connection. Preferably, the second magnetic gripper can be releasably attached to the first magnetic gripper by means of the magnetic gripper interface of the first magnetic gripper. The magnetic gripper point can be formed by releasably attaching the first magnetic gripper to the second magnetic gripper.

The first magnetic gripper and the second magnetic gripper can be arranged next to one another in such a way that, when the number of permanent magnets of the first magnetic gripper are arranged in the Halbach row or in the Halbach matrix, the number of permanent magnets of the second magnetic gripper form a continuation of the Halbach row or the Halbach matrix of the number of permanent magnets of the first magnetic gripper.

Another aspect of the magnetic gripper device can be that the magnetic device enables full-surface gripping of the ferromagnetic workpiece.

In a further development of the magnetic gripper device, a magnetic field of the magnetic apparatus of the first magnetic gripper in the gripping state and a magnetic field of the magnetic apparatus of the second magnetic gripper in the gripping state overlap each other. Advantageously, in the gripping state of the two magnetic grippers, this allows an interruption between the magnetic field of the first magnetic gripper and the magnetic field of the second magnetic gripper to be avoided. This allows the magnetic fields of the two magnetic grippers to act like a single magnetic field in the gripping state. Advantageously, a reduced magnetic force acting on the ferromagnetic workpiece in a transition between the first magnetic gripper and the second magnetic gripper can be thereby avoided. Therefore, the ferromagnetic workpiece gripped by the magnetic gripper device can be gripped particularly securely by the magnetic gripper device.

The magnetic field of the magnetic apparatus of the first magnetic gripper in the gripping state and the magnetic field of the magnetic apparatus of the second magnetic gripper in the gripping state can overlap one another in such a way that the magnetic field of the second magnetic gripper in the gripping state forms a continuation of the magnetic field of the first magnetic gripper in the gripping state.

In a further development of the magnetic gripper device, the magnetic gripper device has a plurality, for example 3, 4, 5, 9 or 16, of magnetic grippers as described above. The plurality of magnetic grippers are arranged to form a magnetic gripper row. Advantageously, this allows the magnetic gripper device can act like a single linear magnetic gripper.

The plurality of magnetic grippers can be structurally identical. The plurality of magnetic grippers can be arranged next to one another to form the magnetic gripping point. The magnetic gripping point can be linear. The magnetic gripper row can have a linear progression. The magnetic grippers can be arranged next to each other in such a way that all workpiece contact surfaces of the magnetic grippers lie in a single plane. Alternatively, the magnetic grippers can be arranged next to one another in such a way that the contours of the workpiece contact surfaces of the magnetic grippers at least partially follow a contour of the ferromagnetic workpiece.

The workpiece contact surfaces of two adjacent magnetic grippers can be spaced apart by the contact surface spacing.

A length of the magnetic gripper row can be equal to or greater than a length of the ferromagnetic workpiece. This allows the magnetic force that acts on the ferromagnetic workpiece gripped by the magnetic gripper device to be constant and/or evenly distributed over the entire length of the ferromagnetic workpiece. This can enable the safe and reliable gripping of particularly delicate workpieces, for example very thin metal sheets.

In a further development of the magnetic gripper device, the magnetic gripper device has a plurality, for example 3, 4, 5, 9 or 16, of magnetic grippers as described above. The plurality of magnetic grippers are arranged to form a magnetic gripper matrix. Advantageously, this allows the magnetic gripper device to act like a single flat magnetic gripper.

The magnetic gripper matrix can be understood as a magnetic gripper grid or a magnetic gripper lattice.

The magnetic gripping point can be flat. The magnetic gripper matrix can be formed by arranging the plurality of magnetic grippers in rows and columns. The magnetic gripper matrix can be arranged in one plane. The magnetic grippers can be arranged next to each other in such a way that all workpiece contact surfaces of the magnetic grippers lie in a single plane. Alternatively, the magnetic grippers can be arranged next to one another in such a way that the contours of the workpiece contact surfaces of the magnetic grippers at least partially follow a contour of the ferromagnetic workpiece.

The workpiece contact surfaces of two adjacent magnetic grippers can be spaced apart by the contact surface spacing.

A length and a width of the magnetic gripper matrix can be equal to or greater than a length and a width of the ferromagnetic workpiece. This allows the magnetic force that acts on the ferromagnetic workpiece gripped by the magnetic gripper device to be constant and/or evenly distributed over the entire length and width of the ferromagnetic workpiece. This can enable the safe and reliable gripping of particularly delicate workpieces, for example very thin metal sheets.

A gripping device according to the invention is designed to grip a ferromagnetic workpiece. The gripping device has a plurality, for example 2, 4 or 6, of magnetic grippers as described above and/or a plurality, for example 2, 4 or 6, of magnetic gripper devices as described above. The plurality of magnetic grippers and/or the plurality of magnetic gripper devices are arranged in a gripping row or in a gripping matrix to form a gripping area.

The plurality of magnetic grippers and/or the plurality of magnetic gripper devices can be arranged in the gripping row or in the gripping matrix if the magnetic grippers and/or the magnetic gripper devices do not act as a single magnetic gripper. In particular, the magnetic fields of the magnetic grippers and/or the magnetic fields of the magnetic gripper devices of the gripping row or the gripping matrix cannot overlap in such a way that the magnetic field of one magnetic gripper or a magnetic gripper device forms a continuation of a magnetic field of another magnetic gripper or another magnetic gripper device of the gripping row or the gripping matrix. Preferably, the number of permanent magnets of a magnetic gripper or a magnetic gripper device of the gripping row or the gripping matrix cannot form a continuation of a Halbach row or a Halbach matrix of the permanent magnets of another magnetic gripper or another magnetic gripper device of the gripping row or the gripping matrix.

The gripping row can be formed by arranging the plurality of magnetic grippers and/or the plurality of magnetic gripper devices in a row.

The gripping matrix can be formed by arranging the plurality of magnetic grippers and/or the plurality of magnetic gripper devices in rows and columns.

The plurality of magnetic grippers and/or the plurality of magnetic gripper devices can be spaced apart from one another by a gripping distance to form the gripping row or the gripping matrix. The gripping distance can be greater than 15 cm, in particular 20 cm, 30 cm or 50 cm.

The workpiece contact surfaces of the magnetic grippers can be arranged within the gripping area. The gripping area can be limited by the internal workpiece contact surfaces of the magnetic grippers. The workpiece contact surfaces of the magnetic grippers can be arranged in one plane. Alternatively, the contours of the workpiece contact surfaces of the magnetic grippers can at least partially follow a contour of the ferromagnetic workpiece.

A gripping system according to the invention has a magnetic gripper as previously discussed, a magnetic gripping device, as previously discussed and/or a gripping device as previously discussed, and the ferromagnetic workpiece. A width and/or a length of the ferromagnetic workpiece is equal to or smaller than a width and/or a length of the workpiece contact surface of the magnetic gripper, a width and/or a length of the magnetic gripping point of the magnetic gripping device, or a width and/or a length of the gripping area of the gripping device. This can advantageously prevent unwanted bending of the ferromagnetic workpiece.

Further advantages and advantageous embodiments of the invention can be found in the figures, the description and the claims. All features disclosed in the figures, their description and the claims can be essential to the invention, both individually and in any combination with one another. In the drawings:

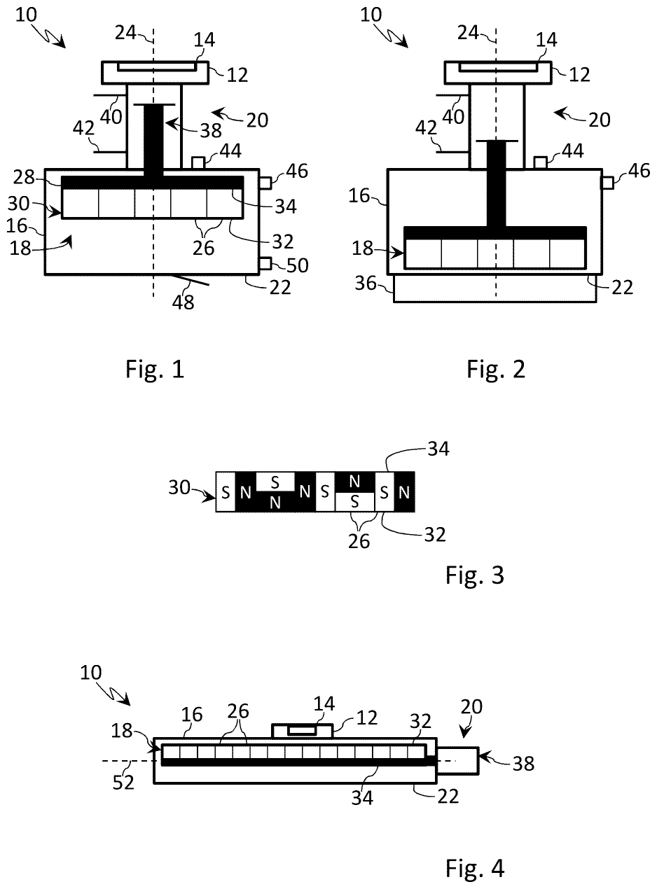

FIG. 1 is a schematic representation of a magnetic gripper with a magnetic apparatus in a release state,

FIG. 2 is a schematic representation of the magnetic gripper of FIG. 1 with the magnetic apparatus in a gripping state,

FIG. 3 is a schematic representation of an arrangement of permanent magnets of the magnetic apparatus of the magnetic gripper of FIG. 1,

FIG. 4 is a schematic representation of another exemplary embodiment of a magnetic gripper with a magnetic apparatus in a release state,

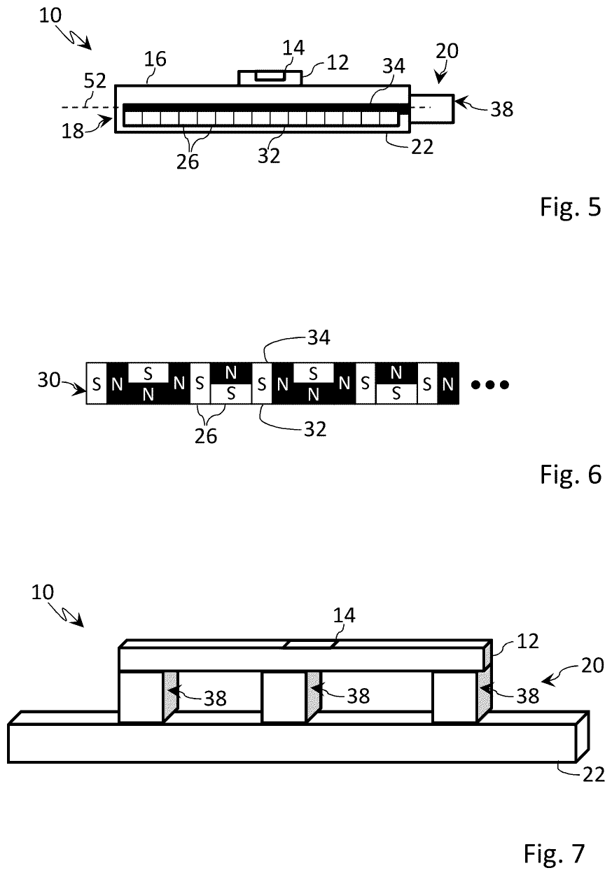

FIG. 5 is a schematic representation of the magnetic gripper of FIG. 4 with the magnetic apparatus in a gripping state,

FIG. 6 is a schematic representation of an arrangement of permanent magnets of the magnetic apparatus of the magnetic gripper of FIG. 4,

FIG. 7 is a schematic representation of another exemplary embodiment of a magnetic gripper,

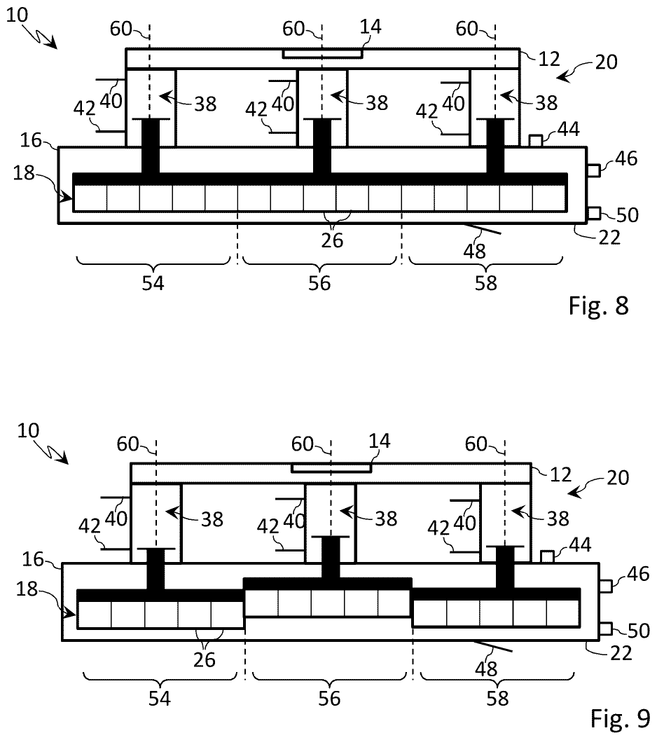

FIG. 8 is a schematic representation of the magnetic gripper of FIG. 7, wherein each magnet unit of the magnetic apparatus is in an active state,

FIG. 9 is a schematic representation of the magnetic gripper of FIG. 7, wherein two magnet units of the magnetic apparatus are in the active state and one magnet unit of the magnetic apparatus is in a passive state,

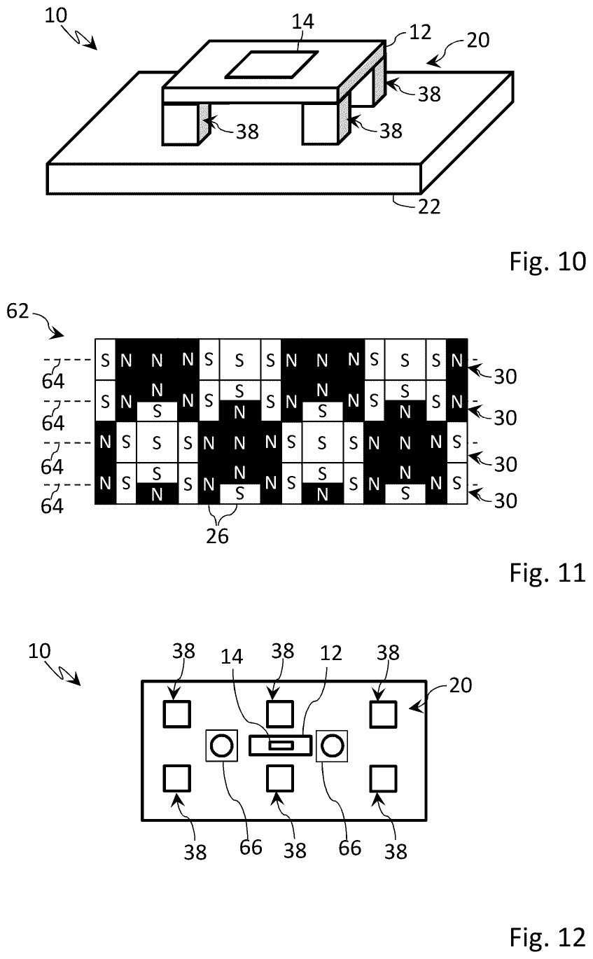

FIG. 10 is a schematic representation of another exemplary embodiment of a magnetic gripper,

FIG. 11 is a schematic representation of an arrangement of permanent magnets of a magnetic apparatus of the magnetic gripper of FIG. 10,

FIG. 12 is a schematic representation of another exemplary embodiment of a magnetic gripper,

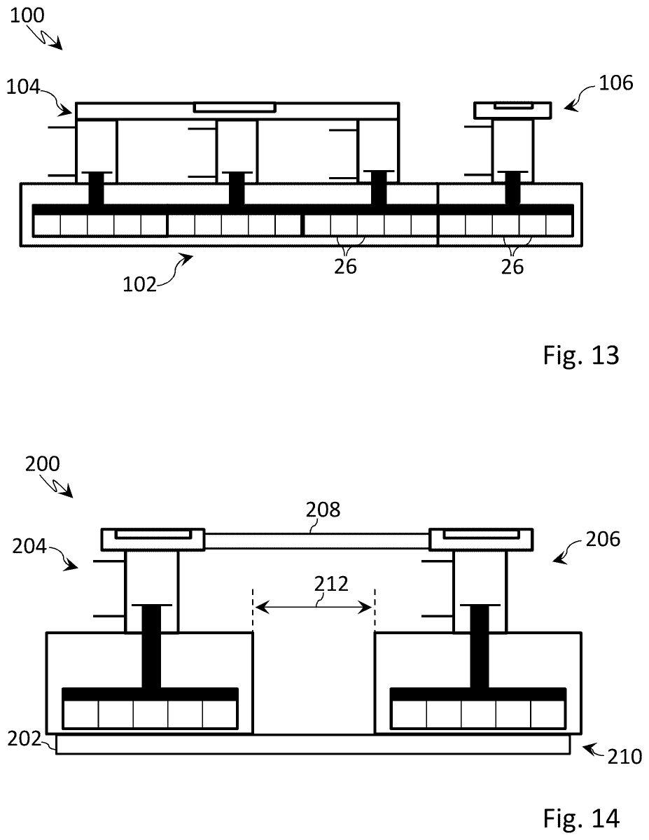

FIG. 13 is a schematic representation of a magnetic gripper device that has the magnetic gripper of FIG. 1 and the magnetic gripper of FIG. 7,

FIG. 14 is a schematic representation of an gripping device; and

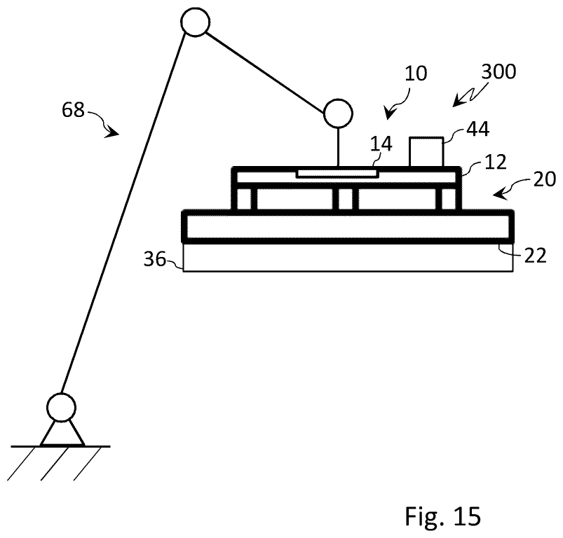

FIG. 15 is a schematic representation of a gripping system with the magnetic gripper of FIG. 7.

FIG. 1 shows a magnetic gripper 10 in a schematic sectional view.

The magnetic gripper 10 has an adapter plate 12 with a handling interface 14 for attaching the magnetic gripper 10 to a handling device. The handling device can, for example, be a manipulator, in particular in the form of a robot arm.

The handling interface 14 is a quick coupling in the form of a bayonet lock. By means of the handling interface 14, the magnetic gripper 10 can be attached to the handling device without tools.

The magnetic gripper 10 is suitable for gripping a ferromagnetic workpiece. The ferromagnetic workpiece can be made of iron or steel. The workpiece can be a metal sheet or a material panel.

The magnetic gripper 10 has a housing 16, a magnetic apparatus 18, a transfer apparatus 20 and a workpiece contact surface 22.

The magnetic apparatus 18 and the transfer apparatus 20 are arranged in the housing 16. The housing 16 is made of aluminum. The housing 16 is elongated. The housing 16 extends along a longitudinal axis 24 of the housing 16. The longitudinal axis 24 of the housing 16 can also be referred to as the longitudinal axis of the magnetic gripper 10. The longitudinal axis 24 is aligned orthogonally to the workpiece contact surface 22.

The housing 16 forms the workpiece contact surface 22. In particular, a flat surface of the housing 16 forms the workpiece contact surface 22. The workpiece contact surface 22 is an end face of the magnetic gripper 10. The workpiece contact surface 22 is provided to contact the ferromagnetic workpiece.

The magnetic apparatus 18 has five permanent magnets 26. Each permanent magnet 26 has a north pole and a south pole. Each permanent magnet 26 generates a magnetic field that extends from the north pole to the south pole of the permanent magnet 26. The magnetic fields of all permanent magnets 26 of the magnetic apparatus 18 form the magnetic field of the magnetic apparatus 18.

The permanent magnets 26 are attached to a magnet holder 28 of the magnetic apparatus 18, in particular in the form of a plate. Each permanent magnet 26 has at least one touching contact with an adjacent permanent magnet 26. In other words, two adjacent permanent magnets 26 have a touching contact between them. The permanent magnets 26 are arranged one after the other to form a permanent magnet row 30. A course of the permanent magnet row 30 is parallel to the workpiece contact surface 22.

The permanent magnet row 30 has a first side 32 facing the workpiece contact surface 22 in the gripping state and a second side 34 facing away from the workpiece contact surface 22 in the gripping state. The first side 32 and the second side 34 are oriented opposite each other. The permanent magnets are arranged one after the other in such a way that a magnetic flux density of the magnetic field of the magnetic apparatus 18 at or through the first side 32 is higher than a magnetic flux density of the magnetic apparatus 18 at or through the second side 34.

FIG. 3 shows a side view of the permanent magnet row 30 with the shown south pole and north pole of the permanent magnets 26. The south pole and the north pole of the permanent magnets 26 are aligned in such a way that the permanent magnet row 30 forms a Halbach row. This ensures that the magnetic field of the magnetic apparatus 18 is concentrated on the first side 32, and the magnetic field of the magnetic apparatus is weakened and/or almost canceled out on the second side 34.

The magnetic apparatus 18 can be transferred between a gripping state for gripping the ferromagnetic workpiece and a release state for releasing the ferromagnetic workpiece.

In the gripping state, the magnetic gripper 10 is designed to generate a magnetic field by means of the magnetic apparatus 18, which causes the ferromagnetic workpiece to be subjected to a magnetic force that is directed onto the workpiece contact surface 22 and is greater than a weight force of the ferromagnetic workpiece. The magnetic force presses the ferromagnetic workpiece against the workpiece contact surface 22.

In the release state, the magnetic apparatus 18 does not generate a magnetic field which is designed to apply to the ferromagnetic workpiece a magnetic force that is directed onto the workpiece contact surface 22 and is greater than a weight force of the ferromagnetic workpiece. This allows the ferromagnetic workpiece to be released from the workpiece contact surface 22.

FIG. 1 shows the magnetic gripper 10 with the magnetic apparatus 18 in the release state, and FIG. 2 shows the magnetic gripper 10 with the magnetic apparatus 18 in the gripping state. Furthermore, FIG. 2 shows that a ferromagnetic workpiece 36 is arranged on the workpiece contact surface 22. By means of the magnetic field of the magnetic apparatus 18, a magnetic force acts on the ferromagnetic workpiece 36 that is greater than the weight force of the ferromagnetic workpiece 36. As a result, the ferromagnetic workpiece 36 is gripped by the magnetic gripper 10.

The ferromagnetic workpiece 36 is smaller than the workpiece contact surface 22. This ensures a uniform distribution of the magnetic force over the entire ferromagnetic workpiece 36.

The magnetic apparatus 18 is mounted in the housing 16 so as to be linearly displaceable parallel to the longitudinal axis 24 of the housing 16.

The magnetic apparatus 18 is brought into the gripping state by a straight translational movement that is directed toward the workpiece contact surface 22. As a result, the permanent magnets 26 are placed so close to the workpiece contact surface 22 that the magnetic field of the permanent magnets 26 penetrates the workpiece contact surface 22 and applies a magnetic force to the ferromagnetic workpiece 36 that is arranged on the workpiece contact surface 22 that is greater than the weight force of the ferromagnetic workpiece 36.

The magnetic apparatus 18 is transferred into the release state by a straight translational movement that is directed away from the workpiece contact surface 22. As a result, the permanent magnets 26 are placed at a distance from the workpiece contact surface 22 in such a way that the magnetic field of the permanent magnets 26 cannot apply to the ferromagnetic workpiece 36 that is arranged on the workpiece contact surface 22 a magnetic force that is greater than a weight force of the ferromagnetic workpiece 36.

The transfer apparatus 20 is designed to transfer the magnetic apparatus 18 between the gripping state and the release state. In the illustrated exemplary embodiment, the transfer apparatus 20 is designed to move the magnetic apparatus 18 pneumatically between the gripping state and the release state.

The transfer of the magnetic apparatus 18 between the gripping state and the release state is carried out by means of an actuator 38 of the transfer apparatus 20. The actuator 38 is a pneumatic drive. The actuator 38 has a piston which is connected to the magnetic apparatus 18. The housing 16 has a first connection 40 and a second connection 42. The two connections 40, 42 are each designed to connect the magnetic gripper 10 to a compressed air supply. The two connections 40, 42 each have an opening for introducing gas, in particular compressed air, into the housing 16 in order to transfer the piston and therefore the magnetic apparatus 18 between the release state and the gripping state.

By supplying gas via the first connection 40, the gas is introduced into a housing section above the piston and exerts pressure on the piston. As a result, a force directed onto the workpiece contact surface 22 acts on the piston. In response thereto, the piston and the magnetic apparatus 18 move parallel to the longitudinal axis 24 toward the workpiece contact surface 22 until the magnetic apparatus 18 assumes the gripping state.

By supplying gas via the second connection 42, the gas is introduced into a housing section below the piston and exerts pressure on the piston. As a result, a force directed away from the workpiece contact surface 22 acts on the piston. In response thereto, the piston and the magnetic apparatus 18 move parallel to the longitudinal axis 24 away from the workpiece contact surface 22 until the magnetic apparatus 18 assumes the release state.

The magnetic gripper 10 has a control apparatus 44 for controlling the transfer apparatus 20. The control apparatus 44 is a microcontroller. The control apparatus 44 is designed to initiate and/or control the supply of gas via the first connection 40 or via the second connection 42.

The magnetic gripper 10 has a detector 46 for detecting a position of the magnetic apparatus 18. The control apparatus 44 is designed to control the supply of gas via the first connection 40 or via the second connection 42 depending on the position of the magnetic apparatus 18 detected by means of the detector 46.

If for example the control apparatus 44 receives a signal for transferring the magnetic apparatus 18 into the gripping state, the control apparatus 44 can initiate a supply of gas to transfer the magnetic apparatus 18 into the gripping state if the position of the magnetic apparatus 18 detected by the detector 46 is not the gripping state. If the position of the magnetic apparatus 18 detected by the detector 46 is the gripping state, the control apparatus 44 cannot initiate the supply of gas.

For example, if the control apparatus 44 receives a signal for transferring the magnetic apparatus 18 to the release state, the control apparatus 44 can initiate a supply of gas to transfer the magnetic apparatus 18 to the release state if the position of the magnetic apparatus 18 detected by the detector 46 is not the release state. If the position of the magnetic apparatus 18 detected by the detector 46 is the release state, the control apparatus 44 cannot initiate the supply of gas.

The magnetic gripper 10 has a sensor apparatus 48 with a presence sensor. The sensor apparatus 48 is designed to detect whether the ferromagnetic workpiece 36 is in contact with the workpiece contact surface 22 or not. The presence sensor is a mechanical sensor that is actuated by the ferromagnetic workpiece 36 when the ferromagnetic workpiece 36 contacts the workpiece contact surface 22.

The control apparatus 44 is designed to initiate and/or control the transfer of the magnetic apparatus 18 between the gripping state and the release state depending on the presence of the ferromagnetic workpiece 36 detected by the sensor apparatus 48.

If for example the control apparatus 44 receives a signal for transferring the magnetic apparatus 18 into the gripping state, the control apparatus 44 cannot initiate and/or control the supply of gas if it is detected by means of the sensor apparatus 48 that the ferromagnetic workpiece 36 is not in contact with the workpiece contact surface 22.

If for example the control apparatus 44 receives a signal for transferring the magnetic apparatus 18 into the gripping state, the control apparatus 44 can initiate and/or control a supply of gas for transferring the magnetic apparatus 18 into the gripping state if it is detected by means of the sensor apparatus 48 that the ferromagnetic workpiece 36 is in contact with the workpiece contact surface 22.

A magnetic gripper interface 50 of the magnetic gripper 10 is arranged on the housing 16 of the magnetic gripper 10 for releasably attaching another, structurally identical magnetic gripper. The magnetic gripper interface 50 has a threaded hole and a through hole for establishing screw connections between the magnetic gripper 10 and the further magnetic gripper for releasably attaching the two magnetic grippers to one another.

The magnetic gripper interface 50 can be designed to supply the further magnetic gripper with compressed air for transferring the further magnetic gripper between the release state and the gripping state.

FIG. 4 to 6 show a further exemplary embodiment of the magnetic gripper 10 of FIG. 1 to 3, wherein the same reference signs are used for identical and functionally equivalent elements and, in this respect, reference can be made to the above explanations regarding the exemplary embodiment of FIG. 1 to 3 so that substantially only the existing differences will be discussed.

FIG. 4 shows the magnetic gripper 10 in the release state, and FIG. 5 shows the magnetic gripper 10 in the gripping state.

The magnetic apparatus 18 is rotatably mounted about a transverse axis 52 of the magnetic gripper 10. The transverse axis 52 runs parallel to the workpiece contact surface 22. The transverse axis 52 can have a course such that the transverse axis 52 does not intersect the permanent magnets 26. In other words, the permanent magnets 26 can be arranged eccentrically with respect to the transverse axis 52. This allows the permanent magnets 26 to be rotated toward or away from the workpiece contact surface 22.

In the gripping state, the permanent magnets 26 can be rotated toward the workpiece contact surface 22. In the release state, the permanent magnets 26 can be rotated away from the workpiece contact surface 22. In other words, in the gripping state, the first side 32 of the permanent magnet row 30 can be arranged between the workpiece contact surface 22 and the second side 34. In the release state, the second side 34 of the permanent magnet row 30 can be arranged between the workpiece contact surface 22 and the first side 32.

The actuator 38 of the transfer apparatus 20 is an electric drive in the form of an electric motor. The actuator 38 drives a rotational movement of the magnetic apparatus 18. By means of the actuator 38, the magnetic apparatus 18 is transferred between the gripping state and the release state by the rotational movement. Each rotational movement for transferring the magnetic apparatus 18 between the gripping state and the release state can cause a rotation of all permanent magnets 26 by 180°.

The magnetic apparatus 18 has fifteen permanent magnets 26. A side view of a section of the permanent magnet row 30 is shown in FIG. 6. The permanent magnet row 30 is a Halbach row.

FIG. 7 to 9 show a further exemplary embodiment of the magnetic grippers 10 of FIG. 1 to 6, wherein the same reference signs are used for identical and functionally equivalent elements and, in this respect, reference can be made to the above explanations regarding the exemplary embodiments of FIG. 1 to 6 so that substantially only the existing differences will be discussed.

FIG. 7 shows the magnetic gripper 10. The transfer apparatus 20 has three actuators 38 for transferring the magnetic apparatus 18 between the gripping state and the release state. The actuators 38 are arranged linearly in a row. The row be called an actuator row. Two adjacent actuators 38 can be spaced apart from each other by a distance.

FIGS. 8 and 9 each show the magnetic gripper 10 of FIG. 7 in a schematic sectional view.

The magnetic apparatus 18 has a first magnet unit 54, a second magnet unit 56 and a third magnet unit 58. Each magnet unit 54, 56, 58 is formed from five permanent magnets 26 of the magnetic apparatus 18.

The transfer apparatus 20 is designed to transfer each magnet unit 54, 56, 58 independently of the other magnet units 54, 56, 58 between an active state and a passive state.

The three actuators 38 are provided for transferring the magnet units 54, 56, 58 between the active state and the passive state. Each actuator 38 is assigned to one of the magnet units 54, 56, 58. Each actuator 38 is designed as a pneumatic drive as previously discussed for the exemplary embodiment of FIG. 1 to 3. Each actuator 38 can transfer the magnet unit 54, 56, 58 assigned to it between the active state and the passive state by a movement along an axis 60 aligned orthogonally to the workpiece contact surface 22.

In the active state of a magnet unit 54, 56, 58, a distance between the magnet unit 54, 56, 58 and the workpiece contact surface 22 is smaller than in the passive state of the magnet unit 54, 56, 58.

FIG. 9 shows the first magnet unit 54 and the third magnet unit 58 each in the active state and the second magnet unit 56 in the passive state.

By adjusting the active states and passive states of the magnet units 54, 56, 58, the magnetic force acting on the ferromagnetic workpiece 36 in the gripping state can be adjusted.

For example, it can be defined that the magnetic gripper 10 is in the gripping state when the first magnet unit 54 and the third magnet unit 58 are each in the active state and the second magnet unit 56 is in the passive state. Alternatively, it can be defined that the magnetic gripper 10 is in the gripping state when all magnet units 54, 56, 58 are each in the active state. This allows the magnetic gripper 10 to be particularly well adjusted to the requirements of the ferromagnetic workpiece 36.

The magnetic gripper 10 is in the release state when all magnet units 54, 56, 58 are each in the passive state.

The control apparatus 44 is designed to initiate and/or control the transfer of each magnet unit 54, 56, 58 between the active state and the passive state by controlling the transfer apparatus 20.

When all magnet units 54, 56, 58 are in the active state or the passive state, the permanent magnets 26 are arranged in the permanent magnet row 30. The permanent magnet row 30 is a Halbach row.

FIGS. 10 and 11 show a further exemplary embodiment of the magnetic grippers 10 of FIG. 1 to 9, wherein the same reference signs are used for identical and functionally equivalent elements and, in this respect, reference can be made to the above explanations regarding the exemplary embodiments of FIG. 1 to 9 so that substantially only the existing differences will be discussed.

FIG. 10 shows the magnetic gripper 10. The transfer apparatus 20 has four actuators 38 for transferring the magnetic apparatus 18 between the gripping state and the release state. The actuators 38 are arranged in a rectangular arrangement, in particular a square arrangement. Such a regular arrangement can be called an actuator matrix.

The magnetic gripper 10 has four magnet units 54 which can be transferred independently of one another between the active state and the passive state by means of the four actuators 38.

FIG. 11 shows a plan view of the permanent magnets 26 of the magnetic gripper 10 in the gripping state with a line of sight from the workpiece contact surface 22 onto the permanent magnets 26.

The permanent magnets 26 are arranged in a permanent magnet matrix 62. The permanent magnet matrix 62 is a Halbach matrix. The Halbach matrix is formed by a sequential arrangement of a plurality of permanent magnet rows 30, each of which is a Halbach row. Each permanent magnet row 30 of the Halbach matrix extends along a longitudinal axis 64. The longitudinal axes 64 of the permanent magnet rows 30 are aligned parallel to each other. The longitudinal axes 64 of the permanent magnet rows 30 define a plane that is parallel to the workpiece contact surface 22.

FIG. 12 shows a further exemplary embodiment of the magnetic grippers 10 of FIG. 1 to 11, wherein the same reference signs are used for identical and functionally equivalent elements and, in this respect, reference can be made to the above explanations regarding the exemplary embodiments of FIG. 1 to 11 so that substantially only the existing differences will be discussed.

The magnetic gripper 10 of FIG. 12 is schematically portrayed in a plan view with a line of sight toward the handling interface 14.

The transfer apparatus 20 has six actuators 38 for transferring the magnetic apparatus 18 between the gripping state and the release state. The actuators 38 are arranged in a regular arrangement, in particular an actuator matrix.

The magnetic gripper 10 has six magnet units 54 which can be transferred independently of one another between the active state and the passive state by means of the six actuators 38.

The magnetic gripper 10 has two grippers 66 for gripping the ferromagnetic workpiece 36. Each gripper 66 is not designed as a magnetic gripper. Each gripper 66 is designed as a suction gripper for gripping the ferromagnetic workpiece 36 by means of a negative pressure. Each gripper 66 can be subjected to a negative pressure to grip the ferromagnetic workpiece 36. By means of the negative pressure, the ferromagnetic workpiece 36 is sucked against the workpiece contact surface 22.

The two grippers 66 are integrated in the permanent magnet matrix 62. In particular, each gripper 66 is integrated into the permanent magnet matrix 62 in such a way that at least one permanent magnet of the permanent magnet matrix 62 is replaced by the gripper 66.

FIG. 13 shows a magnetic gripper device 100.

The magnetic gripper device 100 has a magnetic gripping point 102 for gripping the ferromagnetic workpiece 36, a first magnetic gripper 104 and a second magnetic gripper 106. The first magnetic gripper 104 and the second magnetic gripper 106 are arranged next to each other to form the magnetic gripping point 102. As a result, the two magnetic grippers 104, 106 act like a single magnetic gripper.

A length and/or a width of the magnetic gripping point 102 can be equal to or greater than a length and/or a width of the ferromagnetic workpiece to be gripped.

The first magnetic gripper 104 is structurally identical to the magnetic gripper 10 of FIG. 7 to 9, and the second magnetic gripper 106 is structurally identical to the magnetic gripper 10 of FIG. 1 to 3.

The first magnetic gripper 104 and the second magnetic gripper 106 are detachably connected to one another by means of the magnetic gripper interfaces 50 of the two magnetic grippers 104, 106. In particular, the first magnetic gripper 104 is attached to the second magnetic gripper 106 by means of a screw connection.

By means of the magnetic gripper interfaces 50, the two magnetic grippers 104, 106 are aligned relative to each other so that the workpiece contact surface 22 of the first magnetic gripper 104 and the workpiece contact surface 22 of the second magnetic gripper 106 are arranged in one plane. The magnetic gripping point 102 is formed by the workpiece contact surface 22 of the first magnetic gripper 104 and by the workpiece contact surface 22 of the second magnetic gripper 106. The two magnetic grippers 104, 106 are aligned relative to each other in such a way that the workpiece contact surface 22 of the second magnetic gripper 106 is adjacent to the workpiece contact surface 22 of the first magnetic gripper 104.

The first magnetic gripper 104 and the second magnetic gripper 106 are arranged next to one another in such a way that in the release state and/or in the gripping state of the two magnetic grippers 104, 106, the permanent magnets 26 of the second magnetic gripper 106 form a continuation of the Halbach row of the permanent magnets 26 of the first magnetic gripper 104.

The first magnetic gripper 104 and the second magnetic gripper 106 are arranged next to one another in such a way that the magnetic field of the magnetic apparatus 18 of the first magnetic gripper 104 in the gripping state and a magnetic field of the magnetic apparatus 18 of the second magnetic gripper 106 in the gripping state overlap one another. The magnetic field of the second magnetic gripper 106 in the gripping state forms a continuation of the magnetic field of the first magnetic gripper 104 in the gripping state. As a result, the magnetic fields of the two magnetic grippers 104, 106 act in the gripping state like a magnetic field of a single magnetic gripper.

The first magnetic gripper 104 and the second magnetic gripper 106 are arranged next to each other in such a way that the two magnetic grippers 104, 106 form a magnetic gripper row. As a result, the magnetic gripping point 102 is formed linearly.

In a further exemplary embodiment (not shown), the first magnetic gripper and the second magnetic gripper can be structurally identical.

In a further exemplary embodiment (not shown), the magnetic gripper device can have more than the two magnetic grippers. In particular, the magnetic gripper device can have a plurality of magnetic grippers. The plurality of magnetic grippers can form a single magnetic gripping point.

In a further exemplary embodiment (not shown), the magnetic gripper device can have more than the two magnetic grippers, wherein the magnetic grippers are arranged next to one another to form a magnetic gripper matrix. This allows the magnetic gripping point to be flat. A length and a width of the magnetic gripping point can be equal to or greater than a length and a width of the ferromagnetic workpiece to be gripped.

FIG. 14 shows a gripping device 200 for gripping a ferromagnetic workpiece 202. The gripping device 200 has a first magnetic gripper 204 and a second magnetic gripper 206. The first magnetic gripper 204 and the second magnetic gripper 206 are each structurally identical to the magnetic gripper 10 of FIG. 1 to 3.

The two magnetic grippers 204, 206 are connected to each other by means of a frame 208 of the gripping device 200.

The two magnetic grippers 204, 206 are arranged in a gripping row to form a gripping area 210. The workpiece contact surface 22 of the first magnetic gripper 204 and the workpiece contact surface of the second magnetic gripper 206 are located within the gripping area 210. The gripping area 210 is limited by the inner workpiece contact surfaces 22 of the two magnetic grippers 204, 206. The workpiece contact surfaces 22 of the two magnetic grippers 204, 206 are arranged in one plane. A length and/or a width of the gripping area 210 is equal to or greater than a length and/or a width of the ferromagnetic workpiece 202 to be gripped.

The two magnetic grippers 204, 206 are spaced apart by a gripping distance 212. The gripping distance 212 is more than 15 cm. As a result, the workpiece contact surface 22 of the first magnetic gripper 204 does not adjoin the workpiece contact surface 22 of the second magnetic gripper 206, and the magnetic fields of the magnetic apparatuses 18 of the two magnetic grippers 204, 206 cannot overlap each other in the gripping states. As a result, the magnetic fields of the two magnetic grippers 204, 206 cannot act like a magnetic field of a single magnetic gripper in the gripping states.

FIG. 15 shows a handling device 68 in the form of a robot arm. The magnetic gripper 10 of FIG. 7 is attached to the handling device 68 by means of the handling interface 14. The ferromagnetic workpiece 36 is gripped by the magnetic gripper 10. The magnetic gripper 10 and the gripped ferromagnetic workpiece 36 form a gripping system 300. A width of the ferromagnetic workpiece 36 is equal to a width of the workpiece contact surface 22 of the magnetic gripper 10. A length of the ferromagnetic workpiece 36 is equal to a length of the workpiece contact surface 22 of the magnetic gripper 10.

1. A magnetic gripper (10, 104, 106, 204, 206) for gripping a ferromagnetic workpiece (36, 202), comprising:
a magnetic apparatus (18) that is formed from a number of permanent magnets (26), each with a north pole and a south pole, wherein the magnetic apparatus (18) is transferable between a gripping state for gripping the ferromagnetic workpiece (36, 202) and a release state for releasing the ferromagnetic workpiece (36, 202), a transfer apparatus (20) for transferring the magnetic apparatus (18) between the gripping state and the release state, and
a workpiece contact surface (22) for contacting the ferromagnetic workpiece (36, 202).

2. The magnetic gripper (10, 104, 106, 204, 206) according to claim 1,
wherein the magnetic apparatus (18), when in the gripping state, has a first side (32) facing the workpiece contact surface (22) and a second side (34) facing away from the workpiece contact surface (22),
wherein the number of permanent magnets (26) are arranged in such a way that a magnetic flux density of the magnetic apparatus (18) at or through the first side (32) is higher than a corresponding magnetic flux density of the magnetic apparatus (18) at or through the second side (34).

3. The magnetic gripper (10, 104, 106, 204, 206) according to claim 2,
wherein the number of permanent magnets (26) are arranged in a Halbach row or in a Halbach matrix.

4. The magnetic gripper (10, 104, 106, 204, 206) according to claim 1,
wherein the magnetic apparatus (18) has a first magnet unit (54) that is formed from at least one permanent magnet (26) and a second magnet unit (56) that is formed from at least one permanent magnet (26),
wherein the transfer apparatus (20) is designed to transfer the first magnet unit (54) between an active state and a passive state independently of the second magnet unit (56),
wherein the transfer apparatus (20) is designed to transfer the second magnet unit (56) between an active state and a passive state independently of the first magnet unit (54),
wherein the magnetic apparatus (18) is in the release state when the first magnet unit (54) and the second magnet unit (56) are each in the passive state,
wherein the magnetic apparatus (18) is in the gripping state when the first magnet unit (54) and/or the second magnet unit (56) is in the active state.

5. The magnetic gripper (10, 104, 106, 204, 206) according to claim 1,
wherein the magnetic gripper (10, 104, 106, 204, 206) has a magnetic gripper interface (50) for releasably attaching another magnetic gripper to the magnetic gripper (10, 104, 106, 204, 206).

6. The magnetic gripper (10, 104, 106, 204, 206) according to claim 1,
wherein the magnetic gripper (10, 104, 106, 204, 206) has a number of grippers (66) for gripping the ferromagnetic workpiece (36, 202),
wherein each gripper (66) is designed to grip the ferromagnetic workpiece (36, 202) without a magnetic field.

7. A magnetic gripper device (100) for gripping the ferromagnetic workpiece (36, 202), comprising:
a magnetic gripping point (102) for gripping the ferromagnetic workpiece (36, 202), a plurality of magnetic grippers according to claim 1 that includes a first magnetic gripper (104) and a second magnetic gripper (106) and
wherein the first magnetic gripper (104) and the second magnetic gripper (106) are arranged next to one another to form the magnetic gripping point (102).

8. The magnetic gripper device (100) according to claim 7,
wherein a magnetic field of the magnetic apparatus (18) of the first magnetic gripper (104) in the gripping state and a magnetic field of the magnetic apparatus (18) of the second magnetic gripper (106) in the gripping state overlap each other.

9. The magnetic gripper device (100) according to claim 7,
wherein the plurality of magnetic grippers are arranged to form a magnetic gripper row.

10. The magnetic gripper device (100) according to claim 7,
wherein the plurality of magnetic grippers are arranged to form a magnetic gripper matrix.

11. A gripping device (200) for gripping the ferromagnetic workpiece (36, 202), comprising:
a plurality of magnetic grippers (204, 206) according to claim 1,
wherein the plurality of magnetic grippers (204, 206) are arranged in a gripping row or in a gripping matrix to form a gripping area (210) for gripping the ferromagnetic workpiece (202).

12. A gripping system (300), comprising:
a magnetic gripper (10, 104, 106, 204, 206) according to claim 1, and
the ferromagnetic workpiece (36, 202),
wherein a width and/or a length of the ferromagnetic workpiece (36, 202) is equal to or smaller than a corresponding width and/or corresponding length of the workpiece contact surface (22), than associated width and/or an associated a length of the magnetic gripping point (102), or than a respective width and/or a respective length of the gripping area (210).

13. The magnetic gripper (10, 104, 106, 204, 206) according to claim 2, wherein
the magnetic apparatus (18) has a first magnet unit (54) that is formed from at least one permanent magnet (26) and a second magnet unit (56) that is formed from at least one permanent magnet (26),
the transfer apparatus (20) is designed to transfer the first magnet unit (54) between an active state and a passive state independently of the second magnet unit (56),
the transfer apparatus (20) is designed to transfer the second magnet unit (56) between an active state and a passive state independently of the first magnet unit (54),
the magnetic apparatus (18) is in the release state when the first magnet unit (54) and the second magnet unit (56) are each in the passive state, and
the magnetic apparatus (18) is in the gripping state when the first magnet unit (54) and/or the second magnet unit (56) is in the active state.

14. The magnetic gripper (10, 104, 106, 204, 206) according to claim 2,
wherein the magnetic gripper (10, 104, 106, 204, 206) has a magnetic gripper interface (50) for releasably attaching another magnetic gripper to the magnetic gripper (10, 104, 106, 204, 206).

15. The magnetic gripper (10, 104, 106, 204, 206) according to claim 2,
wherein the magnetic gripper (10, 104, 106, 204, 206) has a number of grippers (66) for gripping the ferromagnetic workpiece (36, 202),
wherein each gripper (66) is designed to grip the ferromagnetic workpiece (36, 202) without a magnetic field.

16. A magnetic gripper device (100) for gripping the ferromagnetic workpiece (36, 202), comprising:
a magnetic gripping point (102) for gripping the ferromagnetic workpiece (36, 202),
a plurality of magnetic grippers according to claim 2 that includes a first magnetic gripper (104) and a second magnetic gripper (106), and
wherein the first magnetic gripper (104) and the second magnetic gripper (106) are arranged next to one another to form the magnetic gripping point (102).

17. A gripping device (200) for gripping the ferromagnetic workpiece (36, 202), comprising:
a plurality of magnetic gripper devices according to claim 7,
wherein the plurality of magnetic gripper devices are arranged in a gripping row or in a gripping matrix to form a gripping area (210) for gripping the ferromagnetic workpiece (202).

18. A gripping system (300), comprising:
a magnetic gripping device (100) according to claim 7, and
the ferromagnetic workpiece (36, 202),
wherein a width and/or a length of the ferromagnetic workpiece (36, 202) is equal to or smaller than a corresponding width and/or a corresponding length of the workpiece contact surface (22), than an associated width and/or an associated length of the magnetic gripping point (102), or than a respective width and/or a respective length of the gripping area (210).

19. A gripping system (300), comprising:
a gripping device (200) according to claim 11, and
the ferromagnetic workpiece (36, 202),
wherein a width and/or a length of the ferromagnetic workpiece (36, 202) is equal to or smaller than a corresponding width and/or a corresponding length of the workpiece contact surface (22), than an associated width and/or an associated length of the magnetic gripping point (102), or than a respective width and/or a respective length of the gripping area (210).

20. The magnetic gripper (10, 104, 106, 204, 206) according to claim 3, wherein
the magnetic apparatus (18) has a first magnet unit (54) that is formed from at least one permanent magnet (26) and a second magnet unit (56) that is formed from at least one permanent magnet (26),
the transfer apparatus (20) is designed to transfer the first magnet unit (54) between an active state and a passive state independently of the second magnet unit (56),
the transfer apparatus (20) is designed to transfer the second magnet unit (56) between an active state and a passive state independently of the first magnet unit (54),
the magnetic apparatus (18) is in the release state when the first magnet unit (54) and the second magnet unit (56) are each in the passive state, and
the magnetic apparatus (18) is in the gripping state when the first magnet unit (54) and/or the second magnet unit (56) is in the active state.
